(19) United States
(12) Patent Application Publication
(10) Pub. No.: US 2021/0350647 A1
(43) Pub. Date: Nov. 11, 2021

(54) METHOD OF PROVIDING AN ELECTRONIC KEY FOR ACCESS TO A WIND TURBINE AND ACCESS CONTROL SYSTEM FOR CARRYING OUT THE METHOD

(71) Applicant: Wobben Properties GmbH, Aurich (DE)

(72) Inventors: Thorsten Jakobs, Großheide (DE); Christoph Behrends, Wiesmoor (DE); Alexander Poolmann, Ihlow (DE)

(21) Appl. No.: 17/314,584

(22) Filed: May 7, 2021

(30) Foreign Application Priority Data
May 11, 2020 (EP) 20173815.0

(51) Int. Cl. G07C 9/23; G07C 9/28; G07C 9/27

(52) U.S. Cl. CPC G07C 9/23; F03D 7/048; G07C 9/27; G07C 9/28

(57) ABSTRACT

A method of providing an electronic key for an access, in particular a control access, to at least one wind turbine or at least one wind farm controller with an access control system, which includes receiving a request for an access to one or more wind turbines selected with the request and/or one or more wind farm controllers selected with the request from an input means or a data interface of the access control system, retrieving data of the one or each of the selected wind turbines and/or the one or each of the selected wind farm controllers by the access control system, and creating and issuing at least one electronic key for the one or each of the selected wind turbines and/or the one or each of the selected wind farm controllers when a criterion is met, wherein a decision as to whether the criterion is met is made depending on the retrieved data by the access control system. An access control system is also provided.

### BACKGROUND

### Technical Field

The invention concerns a method of providing an electronic key for access to at least one wind turbine or at least one wind farm and an access control system.

### Description of the Related Art

According to the state of the art accesses, like control and reading accesses to a wind turbine or a plurality of wind turbines, which, for example, can also be organized in the form of a wind farm, are possible. Access to a plurality of wind turbines which are organized as a wind farm can also be effected by way of a wind farm controller associated with the wind farm. Control and reading accesses to individual wind turbines of a wind farm are therefore frequently implemented in the form of reading and control accesses to a wind farm controller of the wind farm.

In the case of an access, which is a reading access, a user, for example, can read out or retrieve current operating data like the energy which is being fed into the supply grid at the current time. Reading accesses are thus predominantly to be viewed as such accesses, with which no intervention in operation of the wind turbine is involved. A reading access, for example, does not permit any change in operating parameters of a wind turbine by a user. Reading accesses are therefore to be classified as being non-critical for operation and in particular for a supply grid to which the wind turbine the subject of the reading access is connected.

In contrast in respect of accesses which are control accesses, it is possible to act directly or indirectly on operation of the wind turbine or the wind farm controller by, for example, changing operating parameters. Operating parameters are, for example, control variables and the like. By implementing a control access it is, for example, also possible to switch one or more wind turbines on or off or it is possible to vary a level and a voltage or a frequency of an energy which is currently being generated by the wind turbine or turbines and which is being fed into a supply grid. Control accesses therefore involve critical accesses for operation. In particular in the case of inappropriate control of a wind turbine it may be damaged or a supply grid connected to the wind turbine may be affected.

Therefore to obtain control access to a wind turbine or a wind farm controller according to the state of the art authentication of a user is required in relation to a wind turbine or a wind farm controller in order to allow control access only to authorized users. Authentication of a user in accordance with the state of the art is effected, for example, by entering a tuple consisting of password and user identification, with which the user is identified in respect of his identity in relation to the wind turbine or the wind farm controller. In that way control and reading accesses are allowed for the user by delivery to the wind turbine or the wind farm controller.

Users can thus have the authority to also implement system-critical types of control access, which include, for example, switching the wind turbine or the wind farm on and off. With knowledge of the access data of a user who is authorized in that way, more specifically, for example, the tuple comprising the user name and the password, critical control accesses are therefore possible to a wind turbine or a wind farm controller.

In a threat scenario due to human misconduct or sabotage it is accordingly possible, with knowledge of the access data for a plurality of wind farms or wind turbines which, for example, are regionally close together to shut them down at the same time. As a result a supply grid in that region could completely drop out as simultaneous shutdown of a plurality of wind farms means that more energy would be required by consumers than is available from the energy sources connected to the supply grid.

To enhance security therefore efforts have been made to make the provision of control accesses more secure. It is, for example, known for that purpose to issue certificates or electronic keys by a certification authority in a limited number in order in that way to limit the total number of wind turbines to which a control access is made possible. A problem here however is that determination of the number of certificates to be issued must comply with a number of requirements. On the one hand that number must be kept so low that the risk of a supply grid dropping out is reduced or prevented. On the other hand the number must be sufficiently high to be able to ensure that service personnel are allowed unimpeded access to the wind turbines, to which access has to be had within a given service interval and service times scheduled for that.

### BRIEF SUMMARY

One or more embodiments of the present invention are on the one hand to make control accesses to wind turbines and wind farm controllers secure, and on the other hand to ensure that service operations are not adversely affected by the safeguard measures.

According to one embodiment proposed is a method of providing an electronic key for access, in particular a control access, to at least one wind turbine or at least one wind farm controller with an access control system. An electronic key can also be referred to as a token and preferably includes a character string which is provided, for example, in the form of a data file. Accordingly the electronic key preferably includes a software component for identification and authentication of users. The electronic key therefore preferably serves for identifying and authenticating users in relation to a wind turbine or a wind farm controller. The electronic key can also be created in such a way that it allows identification and authentication of users for a plurality of wind turbines and/or a plurality of wind farm controllers, to acquire an access, in particular a control access.

Preferably an electronic key also includes a validity period or an expiry time, in which case the electronic key is then valid only during the validity period or up to the expiry time. A validity period can be, for example, 12 hours or 24 hours. An expiry time can be the end of the day on which the electronic key was issued.

The method includes the receipt of a request for an access, in particular a control access, to one or more wind turbines selected with the request and/or one or more wind farm controllers selected with the request. The request is received by an input means or a data interface of the access control system. Preferably a user therefore submits a request for an access which is preferably a control access to the access control system. The user gives that request to the access control system, for example, by an input means which is a keyboard or a touchscreen or the like of the access control system.

According to an alternative embodiment, the request is received by way of a data interface of the access control system. Particularly preferably the data interface is, for example, an ethernet or Internet connection, by way of which the request is received from a remote computer or a mobile device like, for example, a laptop, a mobile telephone or a tablet PC that the user employs for generating the request. The request also includes a selection of one or more wind turbines and one or more wind farm controllers to which a user wants to have access.

According to a further step in the method, data of the one or each of the selected wind turbines and/or the one or each of the selected wind farm controllers are retrieved by the access control system. The retrieve operation is preferably effected by way of a data connection. The data connection preferably connects the access control system directly to the one or each of the selected wind turbines and/or the one or each of the selected wind farm controllers. In a further preferred alternative the data connection is between the access control system and a further system, wherein the further system has a further or the data connection to the one or each of the selected wind turbines and/or the one or each of the selected wind farm controllers, to retrieve the data. Then in accordance with the alternative the data are retrieved indirectly by the access control system. Accordingly therefore the wind turbine or turbines and/or wind farm controller or controllers which were selected with the request to retrieve data directly or from a further system which has already retrieved the data from the wind turbine or turbines and/or wind farm controller or controllers.

Furthermore the method concerns creating and outputting at least one electronic key for the one or each of the selected wind turbines or turbines and/or the one or each of the selected wind farm controllers if a criterion is met. A decision as to whether the criterion is met is made in dependence on the retrieved data by the access control system.

In summary therefore the access control system outputs one or more electronic keys for selected wind turbines and/or wind farm controllers, after data of those selected wind turbines and/or wind farm controllers are retrieved and after a criterion is met, which is dependent on those retrieved data. The access control system can therefore take account of currently retrieved data of a plurality of wind turbines or wind farm controllers, like operating data which reproduce the respective operating state, in the delivery of an electronic key. It is possible in that way to ensure that the electronic key is created as long as no grid-critical state can occur by the selection of the request upon access to the selected wind turbines or wind farm controllers, even if that access is, for example, the aim of sabotage.

If the request includes, for example, a selection of a plurality of wind farm controllers of a plurality of wind farms and if then by the data being retrieved it happens that all selected wind farm controllers are not yet at all connected to the supply grid by virtue of the erection of the wind farm only just being concluded the access control system can decide that the criterion is met. One or more electronic keys are therefore created in order to obtain full access to all of the selected wind farm controllers. If however alternatively it is established by the retrieved data that one or all wind turbines of the selected wind farms are being operated with their nominal power output or almost their nominal power output and that the wind farms are also still, for example, regionally close together then the access control system decides that the criterion is not met. In that case accordingly no electronic key for access to the wind farm controller is created.

In accordance with a first embodiment with the access control system prior to or with the reception of the request for a control access login data for a user are received by the input means or the data interface of the access control system. The access control system further checks the login data and authorizes the user in dependence on the result of the check for the further steps. Login data include in particular a user name and a password. This therefore creates a security factor in terms of creating the electronic key only by users who can demonstrate valid login data.

According to a further embodiment in the situation where the criterion is met the received data or data derived therefrom are stored in the access control system. In that respect the data are stored in relation to or with reference to the user identified by the login data. Here the received data identify the data directly or indirectly received from the selected wind turbine or turbines and/or the selected wind farm controller or controllers. Data derived from the received data are data which, for example, only have a part of the items of information contained in the received data. In relation to or with reference to the user signifies here that the data, that is to say either the received data or the data derived therefrom, are stored in such a way that on the basis of the stored data it is possible to understand which user has initiated the data retrieval by virtue of his request, based on his selection of the wind turbines and/or wind farm controllers. The derived data can also be data from which it is possible to see, for which of the wind turbines and/or wind farms the user has acquired at least one electronic key. Preferably the validity period or an expiry time for the electronic key created is also stored.

The access control system therefore represents information about the user and the wind turbines or wind farms which were selected by the user and for which an electronic key was created in order in that way to be able precisely to see for which wind turbines or wind farms the user at the time has an electronic key and in particular also for how long that electronic key is still valid.

According to a further embodiment the data stored in relation to or with reference to the identified user additionally serve to decide whether the criterion, in particular in respect of a further or fresh request by the same user, is met or is still met. If therefore a user performs a first request and thereupon an electronic key for the selected wind turbines and/or wind farm controllers is produced as the criterion is met the received data or data dependent on the received data are stored for the user. If that user then sends a fresh request then besides the data retrieved by the fresh request in respect of the wind turbines or wind farm controllers selected with the fresh request the stored data are also taken into consideration in order to check in the access control system whether the criterion is met. It is only then that a further electronic key is created. That ensures that a user cannot acquire an authorization for control access to any number of wind turbines or wind farms solely by a plurality of successively produced requests.

According to a further embodiment in the event of the request being refused, if therefore the access control system takes the decision that the criterion is not met and therefore does not issue an electronic key information derived from the retrieved data and/or the stored data is output. That information includes in particular an indication of the reason for the refusal, more specifically why the criterion is not met. If the criterion, for example, limits the number of wind turbines and/or wind farms to which a user can acquire control access then in the case of a request which correspondingly selects an excessively large number of wind turbines or wind farms information relating thereto is output, which, for example, includes the fact that the number was too high and what number would have been possible.

On the basis of that information a user can then send a modified fresh request to the access control system, in respect of which the criterion is met.

According to a further embodiment the electronic key is produced in such a way that it permits an access, namely a control access, which allows a change in the electrical power produced by one or more selected wind turbines and one or more wind turbines connected to the wind farm controllers. The method therefore serves to provide electronic keys for accesses to wind turbines or wind farms, by which a change in the electrical power generated is made possible.

In a further embodiment the retrieved data includes at least one power value for the selected wind turbine or power values for each respective one of the selected wind turbines and/or wind farms. The criterion can thus be related to power values of all selected wind turbines or wind farms in order in that way to allow electronic keys for control accesses only if the power which can be influenced thereby remains below a limit value which represents the criterion or a part thereof, thereby ensuring that a grid-critical state cannot occur by such influence.

According to a further embodiment the power value of a wind turbine or a wind farm controller includes a current value of a currently generated electrical power of the wind turbine or the wind turbines connected to the wind farm controller. Alternatively or in addition the power value of a wind turbine or a wind farm controller includes a statistical value like, for example, a mean value of an electrical power generated in a predetermined period in the past of the wind turbine or the wind turbines connected to the wind farm controller. Alternatively or in addition the power value includes a predicted value of electrical power of the wind turbine or the wind turbine connected to the wind farm controller. The predicted value is preferably a maximum value or an average value of an electrical power which is expected within a predefined period. The predefined period is preferably a validity period of an electronic key to be created for access to the wind turbine or the wind farm controller.

By virtue of those retrieved data with the power values, which is either a current value, a statistical value or a predicted value, it is possible to estimate what influence a control access can have on a grid if the wind turbine or the totality of the wind turbines which were selected, for example, no longer feed into the grid. If the power value is or includes, for example, a current value then it is possible to detect precisely that situation and an effect on the supply grid by a control access to, for example, all selected installations can be estimated at the present time. A statistical value can here, for example, contribute as an additional value to the current value in order to check how probable it is that the current value changes in the period of time for which, for example, the electronic key maintains validity in order in that way also to be able to estimate the influence of control accesses and to adjust the criterion in that respect. A predicted value of an electrical power of the wind turbine in the retrieved data represents a further possible option for estimating what influence a control access can have on the grid.

According to a further embodiment the access control system sends a power limitation command to the selected or all selected wind turbines and/or the selected or all selected wind farms. The power limitation command serves to limit the electrical power generated, preferably for a validity period of the corresponding electronic key. In particular the power limitation command, preferably for the validity period of the electronic key, provides for restricting or limiting the power for the access to the wind turbine or the wind farm controller. Particularly preferably the power is limited to a value which is equal to or less than the requested current value. Independently of a predicted or statistical value it is possible in that way to ensure that a wind turbine can be so operated at least not in regard to its currently generated power that the power is increased in relation to the current time.

Particularly if a plurality of wind turbines are accordingly operated at a comparatively low power level when the data are retrieved, the number of wind turbines for which an electronic key is produced can be comparatively increased as the power limitation command ensures that even those wind turbines for which the electronic key is produced can only be further operated in such a way that the electrical power is kept comparatively low.

According to a further embodiment a threshold value or a respective threshold value is stored for each identifiable user, which value is the same in particular for each of the users. That threshold value is stored in the access control system. To comply with the criterion the data of the selected or all selected wind turbines and/or wind farms as well as the stored data are compared to the threshold value. The criterion is therefore easily related to, for example, a power which is established as the threshold value. As long as the retrieved data remain below that power value the decision taken is that the criterion is met.

According to a further embodiment a total of all data received as power values, in particular the total of all current values, statistical values or predicted values of the received data, as well as the stored data, are added together. If the sum of the addition is at or below the threshold value the criterion is deemed to be met and an electronic key is created for the wind turbines and/or wind farms from which the data were received. An overall power value can thus be established as a threshold value and electronic keys for wind turbines or wind farms are outputted as long as the power which can influenced thereby remains beneath the threshold value. The criterion therefore corresponds to the requirement that the sum is at or below the predefined threshold value.

According to a further embodiment, the threshold value of an already authorized user, which is, for example, 20MW, can be increased by a further authorized user. Preferably, this is done by receiving login date of the further user from the access control system, checking the login data by the access control system and, if the check is successful, also authorizing the further user. Further, in the event that the access control system receives a request from the further authorized user to increase the threshold value of the already authorized user, the threshold value of the already authorized user is increased. Preferably, therefore, the request includes an amount by which the threshold value of the already authorized user is to be increased. Alternatively, no amount is included in the request and the threshold value of the already authorized user is set to a predefined maximum threshold value, for example, after the request.

Preferably, the request to increase the threshold value allows the threshold value of the already authorized user to be increased by a maximum amount that is assigned to the further authorized user depending on the threshold value of the further authorized user. In particular, however, the threshold value of the further authorized user is reduced by the amount that the threshold value of the already authorized user is increased.

According to an example, if the already authorized user and also the further authorized user are each assigned a threshold value of 20MW, the further authorized user can increase the threshold value of the already authorized user by a maximum of 20MW. If the further authorized user increases the threshold value of the already authorized user by 10MW, for example, the threshold value of the already authorized user is 30MW and the threshold value of the further authorized user is only 10MW.

Double consent or a “four-eyes principle” can thus be used to increase threshold values of authorized users while ensuring that unintended control actions are executed.

According to a further embodiment a table with specific data for each selectable wind turbine and/or each selectable wind farm controller is stored in the access control system. In the situation where the retrieval of data from one of the plurality of wind turbines and/or wind farm controllers fails the specific data for the wind turbine or the wind farm controller, from which no data can be retrieved, are used as the requested data. Accordingly even an electronic certificate can be issued in the situation where one or more wind turbines and/or wind farm controllers do not respond to the data request or have delivered no data to the further system, from which the access control system retrieves the data.

According to a further embodiment the specific data of a wind turbine correspond to the nominal power of the wind turbine and the specific data of a wind farm controller correspond to the sum of the nominal powers of all wind turbines connected to the wind farm controller. That ensures that, if a control access is wanted to a wind turbine or a wind farm controller and that wind turbine does not deliver data directly or indirectly to the access control system it is assumed upon checking of the criterion that the wind turbine or the wind farm controller is feeding in with nominal power. In that situation a total quota of wind turbines or wind farms to be controlled is admittedly possibly excessively severely restricted, in which case at any event even in the case of a fault in the data connection electronic keys can be issued and the supply grid is still protected from attacks by the severe restriction.

In addition, according to one or more embodiments an access control system is adapted to carry out the method according to one of the above-mentioned embodiments.

According to an embodiment of the access control system, the access control system includes an interface for connection to a computer of a user. Alternatively or in addition the access control system is connected by way of a data connection directly or indirectly by way of a further system to a plurality of selectable wind turbines and/or selectable wind farm controllers. The data connection preferably serves to be able to retrieve data of each of the wind turbines and/or wind farm controllers within a predefined retrieval time interval which is preferably less than five minutes or less than one minute or less than five seconds.

### BRIEF DESCRIPTION OF THE SEVERAL VIEWS OF THE DRAWINGS

Further configurations will be apparent from the embodiments by way of example which are described in greater detail with reference to the Figures in which:

FIG. 1 shows a wind turbine,

FIG. 2 shows an access control system connected to a plurality of wind turbines by way of a data connection, and

FIG. 3 shows the steps in the method.

### DETAILED DESCRIPTION

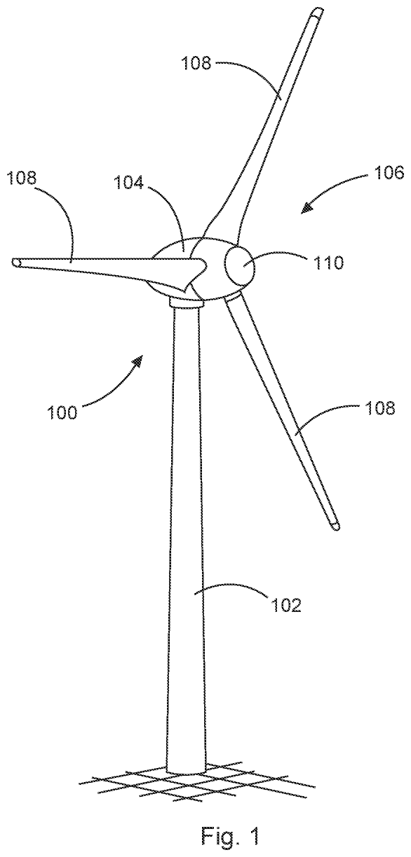

FIG. 1 shows a diagrammatic view of a wind turbine according to the invention. The wind turbine 100 has a tower 102 and a nacelle 104 on the tower 102. Provided on the nacelle 104 is an aerodynamic rotor 106 having three rotor blades 108 and a spinner 110. The aerodynamic rotor 106 is caused to rotate by the wind in operation of the wind turbine 100 and thus also rotates an electrodynamic rotor or rotor member of a wind turbine generator directly or indirectly coupled to the aerodynamic rotor 106. The electrical wind turbine generator is arranged in the nacelle 104 and generates electrical energy. The pitch angles of the rotor blades 108 can be altered by pitch motors at the rotor blade roots of the respective rotor blades.

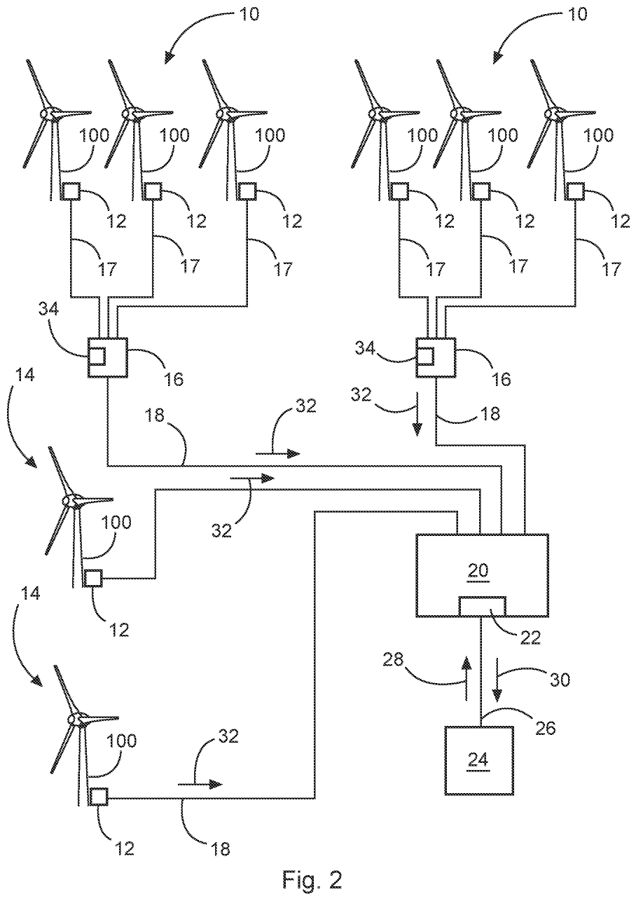

FIG. 2 shows a plurality of wind turbines 100 which are organized either as a wind farm 10 or as individual turbines 14. The wind turbines 100 each have a respective control 12 with which operation of the respective wind turbine 100 is controlled. If the wind turbines 100 are organized as a wind farm 10, the controls 12 are connected to a wind farm controller 16 of the respective wind farm 10 by way of internal data connections 17 in order preferably to coordinate operation of the wind turbines 100 of the respective wind farm 10.

The wind farm controllers 16 are respectively connected to an access control system 20 by way of a data connection 18. The wind turbines 100 organized as individual turbines 14 are also connected to the access control system 20 by way of a data connection 18.

Accordingly instead of a data connection 18 between the wind farm controller 16 and the access control system 20, the data connection 18 in the case of wind turbines 100 organized as individual turbines 14 is connected directly to a control 12 of the respective wind turbine 100.

Even if the data connection 18 in the case of wind turbines 100 organized in the wind farm 10 is connected directly to the wind farm controller 16 there is nonetheless also a connection for direct data exchange by way of the data connection 18 and the respective internal data connection 17 between the individual wind turbines 100 of the wind farm 10 and the access control system 20. Therefore preferably the access control system 20 can also exchange data with the wind turbines 100 of a wind farm 10 by way of the wind farm controller 16 associated with the wind farm 10. Accordingly the access control system 20, by way of the data connections 18, can retrieve data 32 from each illustrated wind turbine 100, therefore in particular from each control 12 of each wind turbine 100 and each wind farm controller 16.

In addition the access control system 20 includes an interface 22 to which a computer 24, which is in particular a remote computer 24, can be connected. The computer 24 is, for example, a mobile device like a portable computer, a tablet PC or a mobile telephone. The computer 24 is connected to the access control system by way of the interface 22 by way of a further data connection 26 in order thus, for example, to send requests 28 to the access control system 20 and receive electronic keys from the access control system 20.

After the computer 24 has received an electronic key 30 from the access control system 20 then, for example, the computer 24 can be connected directly to interfaces 34 which are arranged at the wind farm controllers 16 and also the controls 12 of the wind turbines 100. The electronic key 30 is then used to acquire control access to the connected wind turbine 100 or the connected wind farm controller 16.

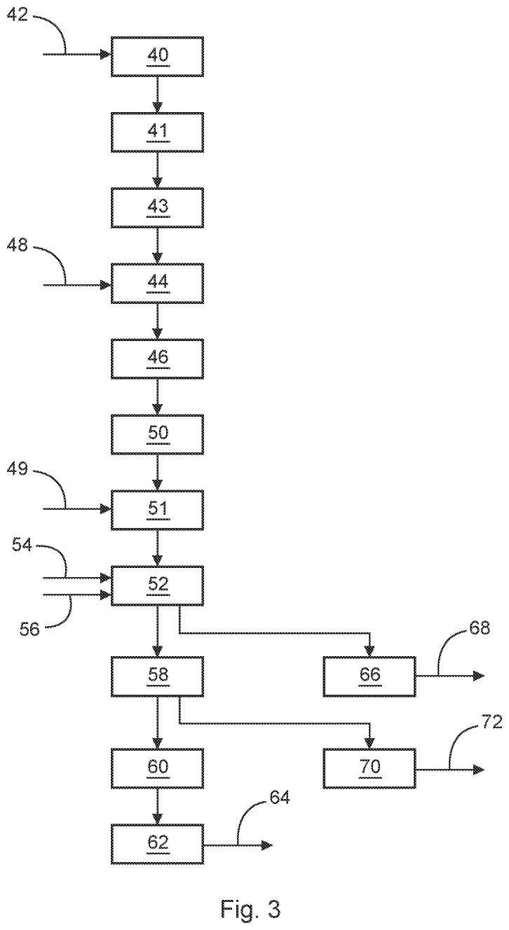

FIG. 3 shows the steps in a method of providing an electronic key 30 to provide access to a wind turbine 100 or a wind farm controller 16 of a wind farm 10. In a step 40 login data 42 are received by the access control system 20 by way of the interface 22. In step 44 the login data 42 are checked and, if those login data 42 identify a user who is stored in the access control system 20 for access to the access control system 20 that user is authorized in a step 43 for the further steps.

In the step 44, after a user has been authorized for the further steps in step 43, a request 48 for access to one or more selected wind turbines 100 and/or one or more selected wind farm controllers 16 is received by way of the interface 22 from the computer 24 of the user. In the subsequent step 46 data are then retrieved from the selected wind turbines 100 and/or wind farm controllers 16, in which case in step 50 the retrieved data 32 are received by the access control system. If a wind turbine 100 and/or wind farm controller 16 does not respond then specific data 49 is requested from a table of the access control system 20 for that non-responding wind turbine 100 and/or the non-responding wind farm controller 16.

In the subsequent step 52 on the basis of the retrieve data 32 and in addition in dependence of data 54 possibly stored for the user identified by the login data 42 a decision is taken as to whether a criterion 56 which is also provided is met. If that criterion 56 is met then in the step 58 at least one electronic key 30 is produced for the selected wind turbines 100 and/or wind farm controllers 16 and issued in the step 60 by way of the interface.

After the step 60 in a step 62 data are stored in relation to or with reference to the user identified by the login data 42, which data correspond either to the received data 32 or data derived therefrom. The stored data 54 are then stored in a memory of the access control system 20.

If the criterion 56 is not met in the step 52 then in a step 66 information 68 as to why the criterion 56 is not met is issued. That information 68 is derived in particular from the retrieved data 32 or the stored data 54. Optionally at the same time as the issue of the electronic key 30 in step 68 a power limitation command 72 is sent in a step 70 to the selected wind turbine and/or the selected wind farm controller 16.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of providing an electronic key for an access a wind turbine or a wind farm controller with an access control system, the method comprising:
receiving a request for an access to the wind turbine or the wind farm controller of an access control system;
retrieving data of the wind turbine or the wind farm controller, by the access control system; and
creating and issuing at least one electronic key for the wind turbine or the wind farm controller when a criterion is met, wherein a decision as to whether the criterion is met is made depending on the retrieved data by the access control system.

2. The method according to claim 1 wherein prior to or with the receiving of the request, receiving login data for a user by an input means or a data interface of the access control system, wherein the login data are checked with the access control system, and wherein depending on a result of the check, the user identified by the login data is authorized for the retrieving the data and the creating and issuing the at least one electronic key.

3. The method according to claim 2 wherein when the criterion is met, the retrieved data are stored in the access control system in relation to or with reference to the user identified by the login data.

4. The method according to claim 2 wherein the decision as to whether the criterion is met is taken in dependence on data stored previously in relation to or with reference to the user identified by the login data.

5. The method according to claim 1, further comprising issuing a refusal of the request, when the criterion is not met, wherein the criterion is not met when the issuing the refusal of the request is based on one or more data chose from the retrieved data and the stored data, and wherein the refusal indicates a reason for the refusal.

6. The method according to claim 1 wherein the at least one electronic key is produced in such a way to permit a control access and allow a change in electric power generated by the wind turbine or of wind turbines of the wind farm controller.

7. The method according to claim 1 wherein the retrieved data includes a power value of the wind turbine or power values of the wind turbines connected to the wind farm controller.

8. The method according to claim 7 wherein a power value of a wind turbine or of wind turbines of the wind farm controller includes at least one value chose from:
a current value of a currently generated electric power of the wind turbine or the wind turbines connected to the wind farm controller;
a statistical value of an electrical power generated in a predetermined period of time with respect to the wind turbine or the wind turbines connected to the wind farm controller; and
a predicted value of an electrical power of the wind turbine or the wind turbines connected to the wind farm controller, wherein the predicted value is a maximum value of an electrical power which is expected within a predefined period of time, wherein the predefined period of time is a validity period of an electronic key to be produced for the access to the wind turbine or the wind farm controller.

9. The method according to claim 1 wherein the access control system sends a power limitation command to the wind turbine or the wind farm controller to limit the power thereof for a validity period of the corresponding electronic key.

10. The method according to claim 9 wherein for the validity period of the electronic key for the access to the wind turbine or the wind farm controller, an electric power generated is limited to a value which is less than or equal to the requested current value.

11. The method according to claim 1, wherein the access control system stores for each identifiable user a threshold value or a respective threshold value, and wherein for the decision as to whether the criterion is met, the data of the wind turbine or the wind farm controller and the stored data are compared to the threshold value.

12. The method according to claim 11 wherein power values, current values, statistical values, or predicted values of the received data for the wind turbine or the wind farm controller and the stored data are added together, and wherein the access control system makes the decision that the criterion is met if the sum of the addition is at or below the threshold value.

13. The method according to claim 11 wherein the threshold value of an already authorized user is increased by another authorized user in such a way that login data are received from the another authorized user by the access control system, the login data are checked by the access control system and, if the check is successful, the another authorized user is authorized to increase the threshold value of the already authorized user thereupon.

14. The method according to claim 13 wherein the threshold value of the already authorized user is increased maximally by an amount which is assigned to the another authorized user depending on the threshold value of the another authorized user, and wherein the threshold value of the another authorized user is reduced by the amount by which the threshold value of the user is increased.

15. The method according to claim 1 wherein stored in the access control system is a table with specific data for the wind turbine and the wind farm controller, wherein in the case where the retrieval of data of the wind turbine or the wind farm controller fails, the specific data from the table for the respective wind turbine or the respective wind farm controller are retrieved and used as retrieved data.

16. The method according to claim 15 wherein the specific data of a wind turbine includes a nominal power of the wind turbine and the specific data of a wind farm controller includes a sum of the nominal power of all wind turbines connected to the wind farm controller.

17. The method according to claim 1 wherein the wind turbine is a plurality of wind turbines, or wherein the wind farm controller is a plurality of wind farm controllers.

18. An access control system configured to carrying out the method according to claim 1.

19. The access control system according to claim 18 wherein the access control system has an interface for connection to a computer of a user.

20. The access control system according to claim 19 wherein the access control system is connected to the wind turbine or the wind farm controller by a data connection in order to retrieve the data from the wind turbine or the wind farm controller within a predefined retrieval interval which is less than five minutes.
